(19) United States
(12) Patent Application Publication
(10) Pub. No.: US 2005/0025433 A1
(43) Pub. Date: Feb. 3, 2005

(54) Optical fiber connection module

(76) Inventor: Chen-Hung Hung, Chia-I Hsien (TW)

Correspondence Address: TROXELL LAW OFFICE PLLC, 5205 LEESBURG PIKE, SUITE 1404, FALLS CHURCH, VA, 22041, US

(21) Appl. No.: 10/628,270

(22) Filed: Jul. 29, 2003

(51) Int. Cl. G02B 6/36

(52) U.S. Cl. 385/88

(57) ABSTRACT

An optical fiber connection module includes a connection tube, a sleeve made by electrocast being securely received in the connection tube, an assembly tube joined with the connection tube at a flange and an optical fiber module securely received in the assembly tube and being coaxial with the sleeve. With the electrocast made sleeve and the coaxial relationship between the optical fiber module and the sleeve, the signal transmission accuracy is upgraded.

### BACKGROUND OF THE INVENTION

1. Field of the Invention

The present invention relates to an optical fiber connection module, and more particularly to the hollow sleeve received in the connection tube of the connection module. The hollow sleeve is electrocast inside the connection tube in the connection module such that the signal transmission precision of the optical fiber is increased.

2. Description of Related Art

With reference to FIGS. 1 and 2, a conventional optical fiber connection assembly is shown and has a hollow body (4) with a sleeve (41) received inside the hollow body (4) and base (5) securely attached to a side of the hollow body (4). An optical fiber module (6) is received inside the base (5) and is coaxial to the sleeve (41) so that signal from the optical fiber module (6) is accurately transmitted through the sleeve (41).

However, because the current sleeve (41) is made of ceramic by means of injection molding. Thereafter, sintering process is applied to bond the ceramic powder. Due to the injection molding method applied to make the sleeve, excessive clearance exists between the molded sleeve and the body (40). Thus additional machining is required to minimize the clearance to match with the body (40), which lengthens the manufacture time period and increases manufacture cost due to additional labor requirement.

To overcome the shortcomings, the present invention tends to provide an improved optical fiber connection module to mitigate the aforementioned problems.

### SUMMARY OF THE INVENTION

The primary objective of the present invention is to provide an improved optical fiber connection module having therein a sleeve formed by electrocast such that signal from an optical fiber module received in the connection module is able to be accurately transmitted.

Other objects, advantages and novel features of the invention will become more apparent from the following detailed description when taken in conjunction with the accompanying drawings.

### BRIEF DESCRIPTION OF THE DRAWINGS

FIG. 1 is perspective view of a conventional optical fiber connection module;

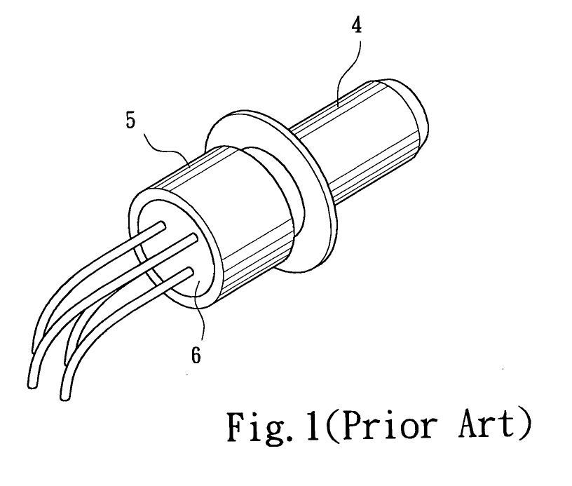

FIG. 2 is schematic cross sectional view of the conventional optical fiber connection module in FIG. 1;

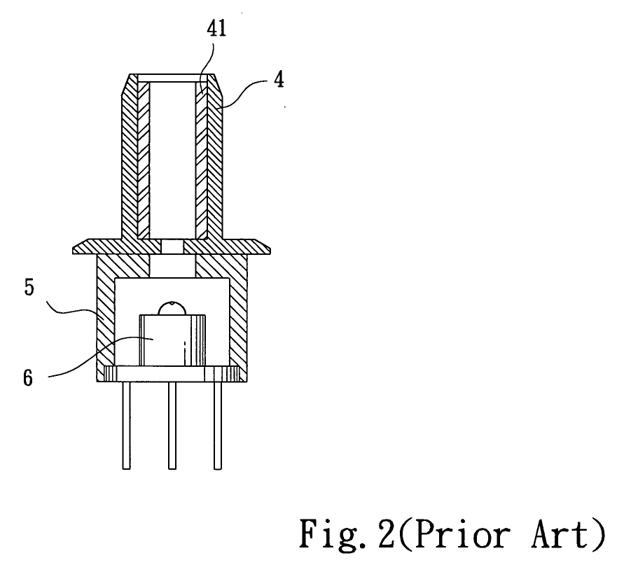

FIG. 3 is a schematic cross sectional view of the optical fiber connection module of the present invention;

FIG. 4 is a schematic cross sectional view of the second embodiment of the optical fiber connection module of the present invention;

FIG. 5 is a schematic cross sectional view of the third embodiment of the optical fiber connection module of the present invention; and

FIG. 6 is a schematic cross sectional view of the fourth embodiment of the optical fiber connection module of the present invention.

### DETAILED DESCRIPTION OF THE PREFERRED EMBODIMENT

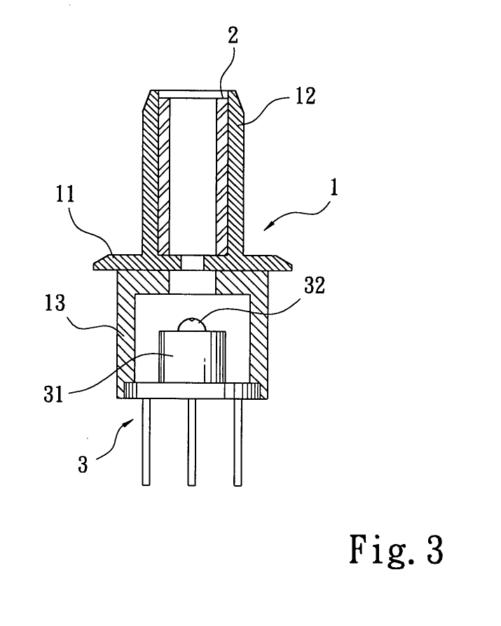

With reference to FIG. 3, the optical fiber connection module (1) in accordance with the present invention includes a connection tube (12) and an assembly tube (13) joined with the connection tube (12) at a flange (11). A sleeve (2) made by electrocast is securely received in the connection tube (12). An optical fiber module (3) provided with a seat (31) and a transceiver (32) mounted on top of the seat (31) is securely received inside the assembly tube (32). The optical fiber module (3) is coaxial with the sleeve (2) so that the signal from the optical fiber module (3) is able to pass through the sleeve (2).

It is to be noted that because the sleeve (2) is made by electrocast, the clearance is minimized when applied to the connection tube (12) thereby not only reducing manufacturing time period, but also reducing manufacturing cost. When electrocast is applied to manufacture an object, the raw material (normally with high rigidity and friction resistance and is in powder form) is applied in an electrolyte. An easy machining tool is used as one electrode where the electrocasted sleeve is formed such that the sleeve is able to be machined accurately to match with the inner diameter of the connection tube (12) and the signal transmission accuracy is upgraded.

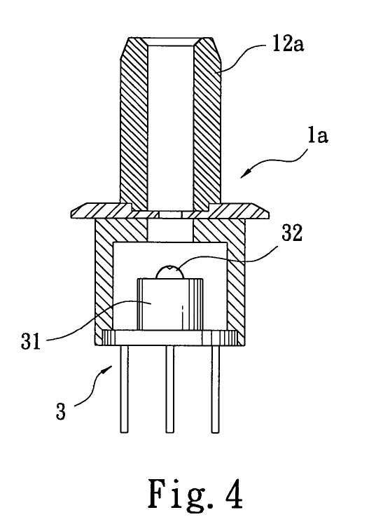

With reference to FIG. 4, it is to be noted that the connection tube (12) in the first embodiment is integrally formed with the sleeve (2). That is, while the electrocast is in operation, the connection tube (12) and the sleeve (2) in the first embodiment are formed into one piece a new form of a connection tube (12a) of the connection module (1a).

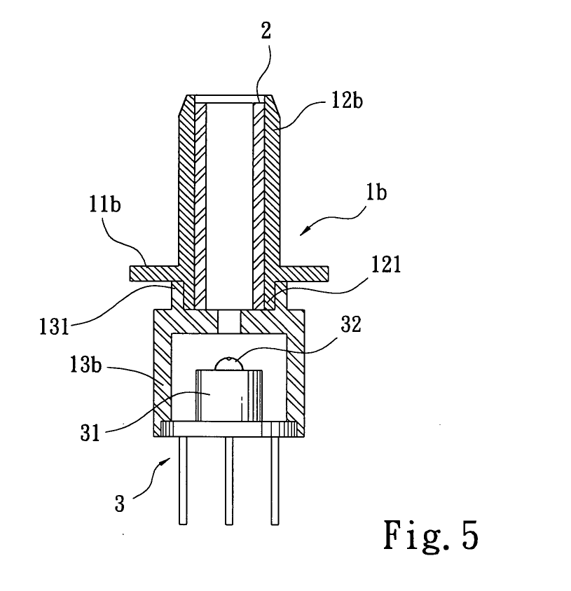

With reference to FIG. 5, the third embodiment of the invention is shown and has a connection tube (12b) and an assembly tube (13b) joined with the connection tube (12b) at a flange (11b), wherein the connection tube (12b) has a first extension (121) extending downward from the flange (11b) and the assembly tube (13b) has a second extension (131) extending upward to securely enclose therein the first extension (121). A sleeve (2) made by electrocast is securely received in the connection tube (12). An optical fiber module (3) provided with a seat (31) and a transceiver (32) mounted on top of the seat (31) is securely received inside the assembly tube (32). The optical fiber module (3) is coaxial with the sleeve (2) so that the signal from the optical fiber module (3) is able to pass through the sleeve (2).

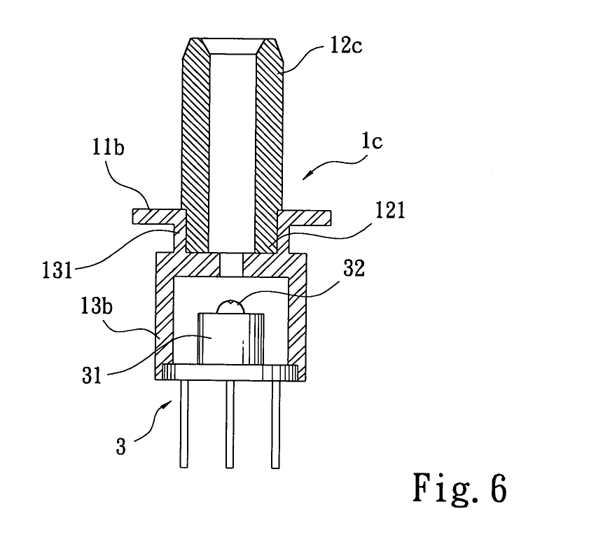

With reference to FIG. 6, it is noted that the sleeve (2) may be formed inside the connection tube (12c) to become one piece with the connection tube (12c). That is, the optical fiber connection module includes a connection tube (12c) and an assembly tube (13b) joined with the connection tube (12c) at a flange (11b), wherein the connection tube (12b) has a first extension (121) extending downward from the flange (11b) and the assembly tube (13b) has a second extension (131) extending upward to securely enclose therein the first extension (121). An optical fiber module (3) provided with a seat (31) and a transceiver (32) mounted on top of the seat (31) is securely received inside the assembly tube (32). The optical fiber module (3) is coaxial with the connection tube (12c) so that the signal from the optical fiber module (3) is able to pass through the sleeve (2).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical fiber connection module comprising:
a connection tube;
a sleeve made by electrocast being securely received in the connection tube; and
an assembly tube joined with the connection tube at a flange; and
an optical fiber module securely received in the assembly tube and being coaxial with the sleeve.

2. The optical fiber connection module as claimed in claim 1, wherein material for making the sleeve has high friction resistance and rigidity.
